(19) United States
(12) Patent Application Publication
(10) Pub. No.: US 2025/0116350 A1
(43) Pub. Date: Apr. 10, 2025

(54) HYDRAULIC DEVICE

(71) Applicant: E.G.O. Elektro-Gerätebau GmbH, Oberderdingen (DE)

(72) Inventors: Antonio Di Maggio, Schwaigern (DE); Uwe Schaumann, Oberderdingen (DE)

(21) Appl. No.: 18/825,069

(22) Filed: Sep. 5, 2024

(30) Foreign Application Priority Data
Oct. 6, 2023 (DE) 10 2023 127 244.6

(51) Int. Cl. F16K 31/53; F16K 27/06; F16K 31/04

(52) U.S. Cl. CPC F16K 31/535; F16K 27/062; F16K 31/043

(57) ABSTRACT

A hydraulic device has rotatable hydraulic means such as a valve actuator or a peristaltic pump, an electric motor as a drive unit, and a gear unit between the drive unit and the hydraulic means, wherein the hydraulic means has at least two water-using ports. In accordance with the invention, the drive unit, the hydraulic means and the gear unit are designed as single function units and are detachably connected to one another as a complete function unit in the form of the hydraulic device. The detachable connection is advantageously achieved by means of screws.

### CROSS-REFERENCE TO RELATED APPLICATIONS

This application claims priority to German Application No. 10 2023 127 244.6, filed Oct. 6, 2023, the contents of which are hereby incorporated herein in its entirety by reference.

### FIELD OF APPLICATION AND PRIOR ART

The invention relates to a hydraulic device with rotatable hydraulic means, which are a valve actuator or a peristaltic pump or gear pump, and with a drive unit and a gear unit in between. The hydraulic means have at least two ports.

### OBJECT AND SOLUTION

The object underlying the invention is to create a hydraulic device mentioned at the outset, using which problems of the prior art can be solved and with which it is possible in particular to improve the design and operation of such a hydraulic device, in particular to allow the hydraulic device to be readily repaired.

This object is achieved by a hydraulic device having the features of claim 1. Advantageous and preferred embodiments of the invention are the subject matter of further claims and are explained in greater detail below. The wording of the claims is incorporated into the content of the description by express reference.

The hydraulic device has rotatable hydraulic means such as a valve actuator or a peristaltic pump or a gear pump. An electric motor is provided as the drive unit, and a gear unit is arranged between the drive unit and the hydraulic means. The gear unit transmits the drive force from the drive unit to the hydraulic means. The gear unit may have gearwheels or other similar transmission means such as belts or the like.

In accordance with the invention, the drive unit, hydraulic means and gear unit are designed as individual function units and are detachably connected to one another as a complete hydraulic device. The function units may thus be designed singly and then connected to one another, and above all be replaced singly in the event that repair is necessary. It is then not necessary to replace the complete hydraulic device, which is less expensive and saves on resources. Repair can also be done faster when it is not necessary to disconnect all water-using or electrical ports of all function units.

In one development of the invention, the gear unit may have a gear housing, wherein the drive unit is detachably fastened to the gear unit or gear housing on the one side and the hydraulic means are detachably fastened on the other side. Advantageously, fastening may be achieved by means of screws, alternatively by other fastening means, which are quick and easy to make and undo, in particular also without complicated tools to do so. The gear housing may be designed robustly enough to provide stability for the complete hydraulic device.

In another development of the invention, the gear unit may have at least two gearwheels that engage in one another, wherein one gearwheel is arranged on a drive shaft of the drive unit. Another gearwheel is arranged on a drive shaft of the hydraulic means. However, more gearwheels than these two may also be provided, for example a total of three or four gearwheels. This allows adjusting of the torque and speed, and also of a distance between the drive unit and the hydraulic means or between their respective drive shafts.

In one embodiment of the invention, an axis of rotation of the drive unit and an axis of rotation of the hydraulic means are parallel to one another. Transmission of force by means of the gear unit, in particular when it has gearwheels, is then easier. Advantageously, the drive unit and the hydraulic means may be arranged on the same side of the gear housing and adjacent to one another. A distance between them may be less than 5 cm or less than 3 cm. This allows the size of the hydraulic device to be kept low for space-saving installation.

In one embodiment, the hydraulic means may be a valve actuator with at least two ports, wherein there may preferably also be three or a maximum of four ports. The ports may here be variously connected or connectable to one another. Advantageously, precisely two ports may be connected or are connected to one another in a fluid-routing manner. The valve actuator is then a water distributor, i.e. it routes liquid in different directions or blocks the throughflow. Alternatively, the valve actuator may be a metering valve of different design and may set the throughflow quantity between two ports, in particular between zero throughflow and maximum throughflow. Generally speaking, the valve actuator may be selected from the following group: metering valve, spherical valve, conical valve, proportional valve, water distributor.

In another embodiment, the hydraulic means may be a peristaltic pump or a gear pump, preferably with two ports. In particular, a liquid may be pumped from always the same first port to always the same second port. A peristaltic pump of this type, also referred to as a hose pump, or a gear pump may be used as a metering pump, in particular in a water-using domestic appliance such as a dishwasher or washing machine. This allows additives or detergents to be metered very precisely and easily for a cleaning operation. To do so, a port of such a pump may be connected to a container for detergents or additives, and extract the latter from the container and pump them out at the other port. They can thus be introduced into a water circuit, for example of a metering device. This type of pump has the major advantage that although it cannot pump large quantities, it may however be designed very simple and sturdy and also meter/pump very precisely.

In a further embodiment of the invention, a direction of fitting for both the hydraulic means and for the drive unit to the gear unit may be a single or uniform direction. Advantageously, this direction is vertical to the adjacent direction from the hydraulic means to the drive unit, or parallel to the axes of rotation of the hydraulic means and the drive unit. A uniform direction of fitting simplifies initial fitting and also repair of the hydraulic device.

In another further embodiment of the invention, a direction of fitting inside the hydraulic means or for fitting of the hydraulic means may correspond to the direction of fitting for the hydraulic means and for the drive unit to the gear unit. In particular, this may be of advantage if the hydraulic means is a valve or a conical valve, but also in the case of other embodiments of the hydraulic means.

Advantageously, a sensor may be arranged on the hydraulic device, in particular this may be a sensor for position detection or for rotary position detection of a valve body or conical valve body of a valve as the hydraulic means. Such a sensor may be designed like a conventional sensor for these detection purposes. It may be arranged both on the drive unit and on the hydraulic means; it should however be arranged on the hydraulic means on account of the higher speed of the drive unit, and because it is mainly intended for position detection or rotary position detection of these hydraulic means.

In one development of the invention, a drive shaft of the hydraulic means may be designed and arranged such that it is freely accessible. This drive shaft moves or carries the valve actuator, and the gear unit engages it or it is connected to the gear unit, in particular to gearwheels or the like inside the gear unit. The drive shaft may extend through the gear unit, advantageously carry at least one gearwheel, and freely project out of it and beyond it on the other side. This free area or this free drive shaft is accessible and may be put to use, for example an aforementioned sensor may be arranged thereon, or thereon and on the gear housing.

In another development of the invention, an actuator preferably designed to move or set the valve actuator may generally be arranged on the valve actuator as hydraulic means, or specifically on a drive shaft or on a gearwheel for that purpose. For example, the valve actuator is a conical valve that can be moved in this way. This allows the valve actuator to be moved in the vertical direction or in the direction along the drive shaft. For example, a conical valve may in effect be undone or loosened for cleaning purposes; it is then flushed out to clean it, and reset as before. Such an actuator may have its own drive unit, for example in electromagnetic or motor form. Alternatively, it may in a simple embodiment also be a screw adjustable manually or using a tool. Additionally, the actuator may have a rotary position detector which is simply a purely mechanical indicator, or alternatively may be an electronic display.

In a further embodiment of the invention, a cover which covers or conceals the hydraulic means may be arranged between the hydraulic means and the gear unit or gear housing. This cover may be for example a lid for the gear unit or gear housing, and advantageously cover an entire side of the gear unit. The cover may be designed such that it can remain on the hydraulic means during or after disconnection of the hydraulic means from the gear unit or from the gear housing. The hydraulic means may remain unmoved, i.e. they do not have to be reset when they are reassembled. This applies for a valve actuator and also for the pumps mentioned. Advantageously, the cover may also be fastened to the gear unit or to the gear housing, whereby the hydraulic means may also be fastened thereto at the same time.

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into sub-headings and individual sections does not limit the statements made thereunder in their general validity.

### BRIEF DESCRIPTION OF THE DRAWINGS

Exemplary embodiments of the invention are illustrated schematically in the drawings and explained in more detail below. In the drawings:

FIG. 1 shows a motor valve in accordance with the invention as a hydraulic device in a side view with the gear unit in section,

FIG. 2 shows a plan view onto the motor valve from FIG. 2 with valve actuator and drive unit on the same side of the gear housing,

FIG. 3 shows an alternative embodiment of a motor valve as the initial equipment with a long gear housing, wherein the valve actuator and drive unit are arranged on different sides, and a representation with drive unit and gear unit replacement,

FIG. 4 shows an enlarged view similar to FIG. 1 of hydraulic means in the form of a valve actuator with valve shaft through the gear unit and with a rotary sensor at the projecting end, and

FIG. 5 shows an exploded view of a further embodiment of a motor valve with a gear housing that has a removable housing cover towards the valve actuator and drive unit.

### DETAILED DESCRIPTION OF THE EXAMPLES

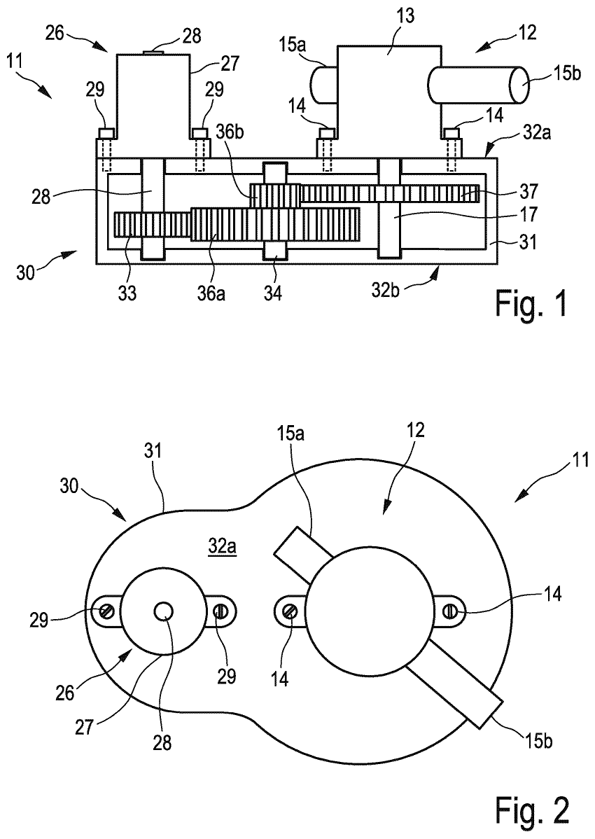

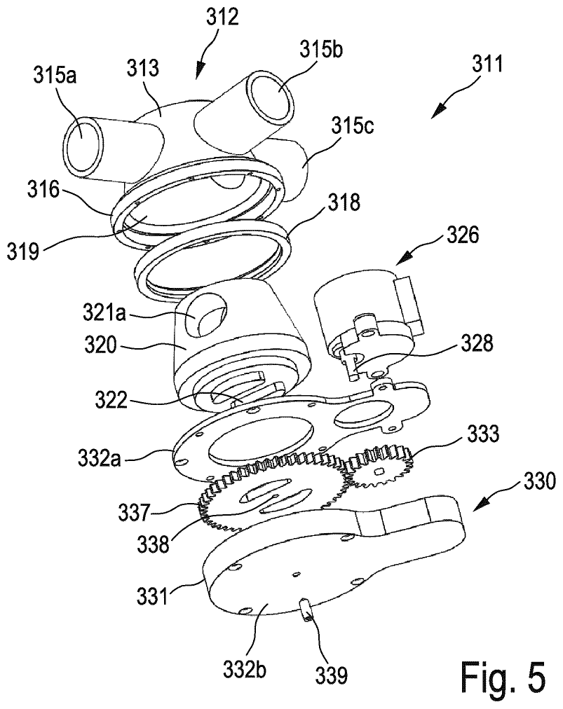

FIG. 1 shows a motor valve 11 in accordance with the invention as the hydraulic device mentioned at the outset. This motor valve 11 may be used for example in a water-using domestic appliance such as a washing machine or dishwasher, but also in many other applications. The motor valve 11 has a valve actuator 12 which is here shown as a through-valve and as a proportional valve with two ports 15a and 15b. The valve actuator 12 has a valve housing 13, which is screwed by means of two screws 14 to a gear unit 30 or to its upper side 32a. The internal design of the valve actuator 12 is not important here, and the valve actuator 12 per se may be designed internally as is known from the prior art. Reference is also made to FIG. 5, in which a special conical valve is described and shown in detail.

The two ports 15a and 15b are opposite one another, which however does not necessarily have to be the case. Furthermore, further ports could also be provided. The valve actuator 12 may thus have up to four ports, in which case the intention is less to regulate a throughflow of liquid or water than to change over as an aforementioned water distributor with a substantially full throughput cross-section in each case.

A drive unit 26 having an electric motor 27 is provided for the valve actuator 12. The electric motor 27 has a drive shaft 28 passing all the way through and extending far into the gear unit 30 or mounted inside a blind hole on an underside 32b of a gear housing 31. The electric motor 27 may be designed in any way required. It may also exert, through the gear unit 30, a torque sufficient to operate the valve actuator 12. The electric motor 27 may be a stepping motor and/or a motor with integrated gear unit.

The drive shaft 28 of the electric motor 27 or of the drive unit 26 is mounted on the far left of the gear housing 31. A drive pinion 33, which is relatively small, is fastened to the drive shaft. It engages in a large lower gearwheel 36a seated on a gearwheel shaft 34. The gearwheel shaft 34 is in turn mounted on the upper side 32a and on the underside 32b in corresponding blind holes. A small upper gearwheel 36b is also arranged on the gearwheel shaft 34, wherein it may be a separate part and fastened thereon. Alternatively, it may be connected in one piece to the lower gearwheel 36a.

The upper gearwheel 36b drives in turn a valve gearwheel 27 which is considerably larger. The valve gearwheel 37 is fastened on the previously mentioned valve shaft 17. The valve shaft 17 is mounted at the bottom inside a blind hole in the underside 32b and extends at the top into the valve actuator 12, for example to operate the valve body, valve balls, pistons or the like.

By undoing the screws 14 on the valve actuator 12 on the one side, or the screws 29 on the drive unit 26 on the other side, each of these two components may be detached from the motor valve 11 or structural unit respectively and then replaced. This may be done when one of the parts is defective or when requirements or performance specifications change. Accordingly, the gear unit 30 alone may also be replaced, in particular when it is defective.

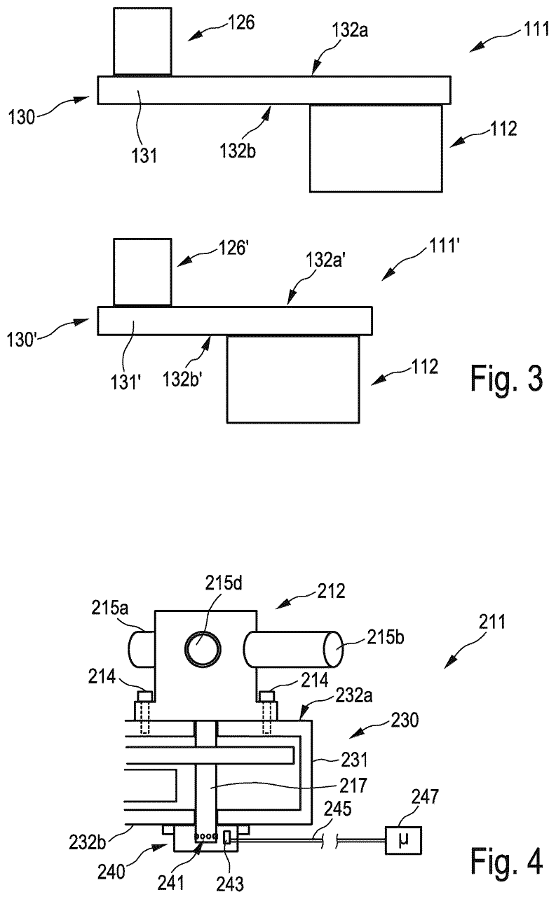

FIG. 3 shows at the top a motor valve 111 as initially manufactured and installed in a washing machine, for example. The motor valve 111 has a gear unit 130 with a gear housing 131, which has an upper side 132a and an underside 132b. A valve actuator 112 is fastened to the underside 132b in the right-hand area, advantageously also by means of screws. In the left-hand area, a drive unit 126 is arranged on the other side of the gear housing 131, i.e. on the upper side 132a. This is of course possible and easy to implement within the framework of the invention.

FIG. 3 shows at the top a repaired motor setting valve 111′, which may be similar overall with regard to the valve functions, although this is not essential. It should however still be installed in the same apparatus. The valve actuator 112 is unchanged, i.e. the same, when the motor valve 111′ is changed. On the one hand, the drive unit was replaced, the current drive unit 126′ being somewhat longer and having instead a smaller diameter. It is also a standard component, but from a different series than the old drive unit 126. If may have replaced the old drive unit 126, for example in the course of a repair. This may be because the new drive unit 126′ is more efficient, or alternatively because the old drive unit 126 was no longer functioning and an identical drive unit was or is no longer available.

On the other hand, the gear unit 130′ too is changed, with the gear housing 131′ being considerably shorter, by around 12% to 15%. This too may be because the old gear unit 130 was no longer available. It is thus possible to continue using the valve actuator 112 and to replace the other two main components. As a rule, only a single component will be replaced. It is important here, for the embodiment of the gear housing, valve actuator or hydraulic means in general and the drive unit, only that they fit together when connected, in particular that the gear unit individually fits the valve actuator, or the hydraulic means and drive unit in general.

FIG. 4 shows in an enlargement that a valve shaft 217 projects into a gear unit 230 or its gear housing 231 from a valve actuator 212 with four outlets 215a, 215b and 215d, the fourth outlet not being discernible. Above all, however, the valve shaft 217 projects through the gear housing 231 and thus extends from the valve actuator 212 on the upper side 232a to beyond the underside 232b. A rotary sensor 240 is here provided on the underside 232b. The rotary sensor 240 is in general intended to precisely determine a rotary position of the valve shaft 217 and hence of the valve actuator 212, and make the position usable as a signal. One possibility shown here by way of example has a ring of optical markings 241 at the free lower end of the valve shaft 217, or said ring is provided here. The optical markings 241 may be designed for example alternatingly as black and white stripes or as reflecting and non-reflecting surfaces. Next to them on the right, a light sensor 243 is provided that scans these optical markings 241, advantageously by means of emitted and possibly reflected light, and detects the rotary position from that or can detect it from the change in the rotary position. Rotary sensors of this type are known in many forms to the person skilled in the art.

The rotary sensor 240 or the light emitter 243 is connected to a control 247 by means of a connecting cable 245. This control may also control further functions, in particular the drive unit for the valve actuator 212. A possible improvement to the accuracy in detection of the rotary position may be achieved by connecting the control 247 also to the drive unit or to a power supply or to a power control system therefor. If a rotary sensor is also included in the drive unit itself, for example as an increment encoder, then the control 247 is advantageously also connected thereto.

FIG. 5 shows a further motor valve 311, wherein the valve actuator 312 is here designed as a so-called water distributor, and furthermore as a so-called conical valve. The valve actuator 312 has a valve housing 313 with three ports 315a, 315b and 315c. At the bottom of the valve housing 313, a flanged ring 316 is provided to assist screwing onto a gear unit 330. This is explained below. A sealing ring 318 is also provided here, which seals the valve housing 313 against the gear unit 330.

A conical valve body 320 is provided as the valve body and is designed to fit a conical valve seat 319 formed on the inside of the valve housing 313. The conical valve body 320 has three holes 321, of which only one hole 321a is shown here. The holes 321 in the conical valve body 320 are designed such that any two of the ports 315a to 315c are connected in liquid-routing manner to one another while the other one is blocked. The valve actuator 312 is therefore used here less for regulation of a volumetric flow in respect of its strength or flow rate than for routing or diverting a liquid flow as a water distributor.

Two projections 322 are formed on the underside of the conical valve body 320, which engage in corresponding recesses in the valve gearwheel 337 instead of the previously explained valve shaft, thus ensuring a torque-transmitting connection. Additionally, a grub screw 339, designed pointed at its upper end, is screwed into an underside 332b of a gear housing 331 in an extension of the axis of rotation of the conical valve body 320. It engages in a recess 338 in the valve gearwheel, and on the one hand it is used for centering, and on the other hand it is also possible, by screwing in or unscrewing the grub screw 339, to set the pressure with which the valve gearwheel 337 presses against the conical valve body 320 and presses the latter further into the valve housing 313 or against the conical valve seat 319. This allows the rotation resistance to be set, but at the same time also the tightness of the valve actuator 312 or water distributor in conjunction with the design of the gasket 318 and the applied pressure in the ports 315a to 315c. Instead of such a grub screw that engages with its tip in the recess 338, another pressing element having a ball instead of the point may also be used, in particular a springy or springily designed pressure piece. The conical valve body 320 can then be pressed in springy manner against the conical valve seat 319.

As a further special feature, the gear housing 331 is provided here with a separate upper side 332a removable as a cover. This upper side 332a may be firmly screwed, by means of four screws distributed around the valve housing 313, to the remaining gear housing 331. The valve actuator 312 is then firmly screwed, with four screws each turned 45° thereto, to the upper side 332a, using the aforementioned flanged ring 316. The valve actuator 312 can thus be removed, for example for replacement, while the gear unit 330 remains closed and hence the valve gearwheel 337 and a drive pinion 333 remain unchanged in their position. This allows the position of the gear housing 331 to be changed relative to the ports 315a to 315c too, which also relates to the position of the drive unit 326.

This drive pinion 333 is seated on a drive shaft 328 of the drive unit 326 that is already provided with a small integrated gear unit here, which does not however play any role. The drive unit 326 may be firmly screwed to the upper side 332a by means of two screws.

As was previously explained, in the case of the motor valve 311 of FIG. 5 too, each of the three main components may be replaced. Changing the valve actuator 312 and the drive unit 326 is particularly simple, as each of them has to be detached or unscrewed from the gear unit 330 only individually. They are thus very easy to handle in the event of replacement. If the gear unit 330 has to be replaced, this is somewhat more complex, but still feasible. It is only important that the interfaces between gear unit 330 and drive unit 326 on the one side, and gear unit 330 and valve actuator 312 on the other, are the same and also fit. Furthermore, the entire structural size should not differ too greatly, so that it can still be fitted into the given installation situation.

1. A hydraulic device having:
rotatable hydraulic means such as a valve actuator or a peristaltic pump or a gear pump, wherein said hydraulic means has at least two ports,
an electric motor as a drive unit for said rotatable hydraulic means, and
a gear unit between said drive unit and said hydraulic means,
wherein said drive unit, said hydraulic means and said gear unit are designed as single function units and are detachably connected to one another as a complete hydraulic device.

2. The hydraulic device according to claim 1, wherein said gear unit has a gear housing, wherein said drive unit is detachably fastened to said gear unit or said gear housing on one side, and wherein said hydraulic means are detachably fastened on another side.

3. The hydraulic device according to claim 1, wherein said gear unit has at least two gearwheels that engage in one another, wherein one said gearwheel is arranged on a drive shaft of said drive unit and another one said gearwheel is arranged on a drive shaft of said hydraulic means.

4. The hydraulic device according to claim 1, wherein an axis of rotation of said drive unit and an axis of rotation of said hydraulic means extend parallel to one another.

5. The hydraulic device according to claim 4, wherein said gear unit has a gear housing and wherein said drive unit and said hydraulic means are arranged on a same side of said gear housing and adjacent to each other.

6. The hydraulic device according to claim 5, wherein said hydraulic means are adjacent to said drive unit at a distance of less than 5 cm.

7. The hydraulic device according to claim 1, wherein said hydraulic means is a valve actuator with at least two ports or with a maximum of four ports.

8. The hydraulic device according to claim 7, wherein a maximum of two said ports is connected to one another in a fluid-routing manner.

9. The hydraulic device according to claim 7, wherein said valve actuator is selected from a group of: spherical valve, conical valve, proportional valve, metering valve, water distributor.

10. The hydraulic device according to claim 1, wherein said hydraulic means is a peristaltic pump with two ports.

11. The hydraulic device according to claim 10, wherein a liquid is pumpable from always one first port to always a second port, wherein said first port and said second port are always the same.

12. The hydraulic device according to claim 1, wherein a direction of fitting both for said hydraulic means and for said drive unit to said gear unit is a single direction or a uniform direction.

13. The hydraulic device according to claim 12, wherein said direction of fitting both for said hydraulic means and for said drive unit to said gear unit is a single direction vertical to an adjacent direction between said hydraulic means and said drive unit.

14. The hydraulic device according to claim 12, wherein said direction of fitting both for said hydraulic means and for said drive unit to said gear unit is a direction parallel to said axes of rotation of said hydraulic means and said drive unit.

15. The hydraulic device according to claim 1, wherein a direction of fitting inside said hydraulic means corresponds to a direction of fitting for said hydraulic means and for said drive unit to said gear unit.

16. The hydraulic device according to claim 1, wherein a direction of fitting for fitting of said hydraulic means corresponds to a direction of fitting for said hydraulic means and for said drive unit to said gear unit.

17. The hydraulic device according to claim 1, wherein said hydraulic means is designed as a valve with a valve body, wherein a sensor for detecting a position of said valve body is arranged on said hydraulic device.

18. The hydraulic device according to claim 1, wherein said hydraulic means has a drive shaft, wherein said drive shaft is freely accessible and passes through said gear unit and freely projects beyond said gear unit on another side.

19. The hydraulic device according to claim 18, wherein a sensor device is arranged on said drive shaft being freely accessible.

20. The hydraulic device according to claim 1, wherein an actuator is arranged on said drive shaft of said valve actuator, wherein said actuator is designed to set or move said valve actuator in said vertical direction.

21. The hydraulic device according to claim 20, wherein said actuator has a rotary position detection.

22. The hydraulic device according to claim 1, wherein an actuator is arranged on said drive shaft of said valve actuator, wherein said actuator is designed to set or move said valve actuator in a direction along said drive shaft.

23. The hydraulic device according to claim 1, wherein a cover which covers or conceals said hydraulic means is arranged between said hydraulic means and said gear unit, wherein said cover is designed such that it remains on said hydraulic means during or after disconnection of said hydraulic means from said gear unit.

24. The hydraulic device according to claim 1, wherein said gear unit has a gear housing and wherein a cover, which cover covers or conceals said hydraulic means, is arranged between said hydraulic means and said gear unit or said gear housing, wherein said cover is designed such that it remains on said hydraulic means during or after disconnection of said hydraulic means from said gear unit or from said gear housing.

25. The hydraulic device according to claim 24, wherein said cover is fastened to said gear unit or to said gear housing.
